(19) United States
(12) Patent Application Publication
(10) Pub. No.: US 2014/0137091 A1
(43) Pub. Date: May 15, 2014

(54) AUTOMOBILE OPEN SYSTEM ARCHITECTURE(AUTOSAR)-BASED ELECTRONIC CONTROL UNIT (ECU) AND METHOD FOR UPDATING ECU

(71) Applicant: Electronics and Telecommunications Research Institute, Daejeon-si (KR)

(72) Inventor: Jong-Uk KIM, Daegu-si (KR)

(21) Appl. No.: 13/930,415

(22) Filed: Jun. 28, 2013

(30) Foreign Application Priority Data
Nov. 13, 2012 (KR) 10-2012-0128349

(51) Int. Cl. G06F 9/445

(52) U.S. Cl. CPC G06F 8/65
USPC 717/168

(57) ABSTRACT

An Automobile Open System Architecture (AUTOSAR)-based Electronic Control Unit (ECU) and a method for updating the ECU are provided. The ECU includes a communication driver; a communication hardware abstraction unit configured to receive data to be updated from a communication driver; and an ECU update unit configured to update an ECU using the received data.

### CROSS-REFERENCE TO RELATED APPLICATION

This application claims the benefit under 35 U.S.C. §119(a) of Korean Patent Application No. 10-2012-0128349, filed on Nov. 13, 2012, in the Korean Intellectual Property Office, the entire disclosure of which is incorporated herein by reference for all purposes.

### BACKGROUND

1. Field

The following description relates to an Automobile Open System Architecture (AUTOSAR)-based Electronic Control Unit (ECU), and more specifically, to a technology for updating software of the ECU.

2. Description of the Related Art

As the electrical and electronic structure of a vehicle becomes more complicated, the amount and degree of complexity of software used to control the vehicle have also increased. Therefore, the period of time required to develop software has increased, and the probability of having defects in the software has increased. Indeed, many vehicles have been recalled because of defects in the software. Furthermore, with the rapid development of semiconductors and computer technologies, enterprises, which produce the electrical and electronic products of vehicles, have revealed new product with more improved performance shortly after the release of previous models. Therefore, vehicle enterprises have to frequently improve vehicle software.

With the increasing importance of issues of safety and productivity in the vehicle industry, the need for a software platform which assures reliability and reusability has increased. AUTOSAR is the vehicle's electronic software standard platform which was developed for the purpose of such reliability and reusability, and a plurality of vehicle companies are concentrating their energies on developing a commercial vehicle which operates on an AUTOSAR platform. The AUTOSAR platform includes Electronic Control Units (ECUs) which are basic vehicle control units. Each of the ECUs include Basic Software Modules (BSMs) used to perform functions, software components which operate on the ECUs, and an AUTOSAR Run-Time Environment (RTE) which supports communication between ECUs. Such a BSM may be variously set based on the environment and the supported function of an ECU. The AUTOSAR provides a standard for the specification and configuration of each of the BSMs.

### SUMMARY

The following description provides a method which is helpful for an application developer and allows an Electronic Control Unit (ECU) to be updated at a high speed by extending an AUTOSAR communication interface driver.

In one general aspect, an Automobile Open System Architecture (AUTOSAR)-based Electronic Control Unit (ECU) is provided, and the AUTOSAR-based ECU includes a communication driver; a communication hardware abstraction unit configured to receive data to be updated from a communication driver; and an ECU update unit configured to update an ECU using the received data.

The ECU update unit may update the ECU by receiving the data directly from the communication hardware abstraction unit, rather than transmitting the data to a User Application via a Protocol Data Unit Router (PDUR), a COM and a RunTime Environment (RTE).

When updating the ECU, the ECU update unit may be capable of selecting whether to operate an Operating system (OS).

The ECU update unit may, in a first mode, update the ECU when the OS is operating, and, in a second mode, stop operation of the OS to update the ECU and then re-operate the OS when the ECU is completely updated.

The ECU update unit may, in the second mode, update the ECU by activating Controller Area Network (CAN) interrupts required for updating the ECU while stopping all interrupts except for CAN interrupts.

The ECU update unit may, in the second mode, update the ECU using a polling method while stopping all interrupts including CAN interrupts.

The ECU update unit may set a parameter required for updating an area in a memory to be updated, and then set a different driver to be selectively used.

The communication driver may include a CAN driver.

The communication hardware abstraction unit may include a CAN interface.

In another general aspect, a method for updating an AUTOSAR-based ECU is provided, and the method includes receiving, in a communication hardware abstraction unit, data to be updated from a communication driver data; and updating an ECU in the ECU update unit using the data received from the communication hardware abstraction unit.

The updating of an ECU may include updating the ECU by receiving the data directly from the communication hardware abstraction unit, rather than transmitting the data to a User Application via a PDUR, a COM and a RTE.

The updating of an ECU may include either or both of, in a first mode, updating an ECU when an OS is operating, and, in a second mode, updating the ECU by stopping operation of the OS.

The updating of an ECU in the second mode may include updating the ECU by activating only CAN interrupts required for updating the ECU while stopping other interrupts.

The updating of an ECU in the second mode may include suspending all interrupts, including CAN interrupts, and updating the ECU based on a polling method.

The updating of an ECU may include setting a parameter required for updating an area in a memory to be updated and then setting a different driver to be selectively used.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of an Automobile Open System Architecture (AUTOSAR)-based Electronic Control Unit (ECU);

FIG. 2 is diagram illustrating a configuration of an ECU which is updated in accordance with an extended AUTOSAR standard;

FIG. 3 is a flow chart illustrating a method for updating an ECU according to an exemplary embodiment of the present invention;

FIG. 4 is a flow chart illustrating a method for updating an ECU according to another exemplary embodiment of the present invention; and

FIG. 5 is a flow chart illustrating a method for updating an ECU according to another exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

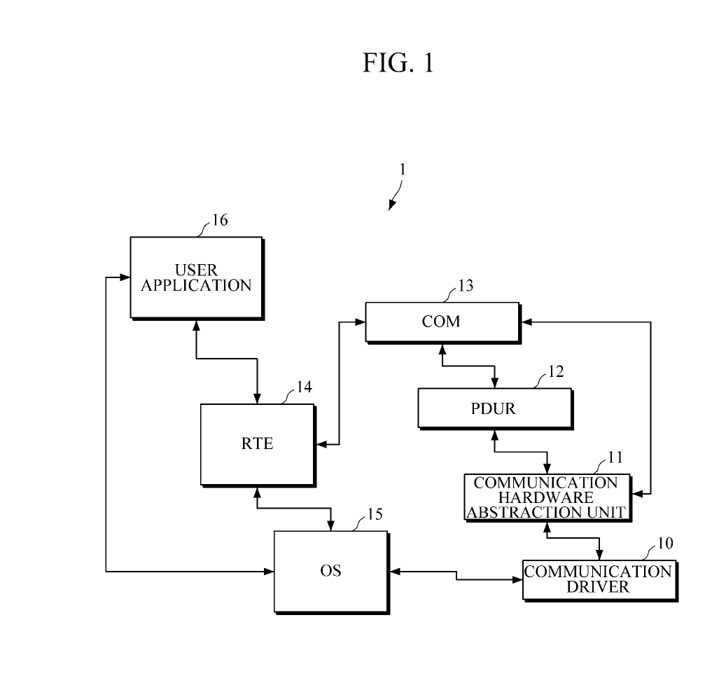

FIG. 1 is a diagram illustrating a configuration of an Automobile Open System Architecture (AUTOSAR)-based Electronic Control Unit (ECU) 1.

Referring to FIG. 1, the AUTOSAR-based ECU 1 includes a communication driver 10, a communication hardware abstraction unit 11, a Protocol Data Unit Router (PDUR) 12, a COM 13, a RunTime Environment (RTE) 14, an AUTOSAR Operating System (OS) 15, and a User Application 16.

Recently, instead of being detached, the AUTOSAR-based ECU is updated using a communication means, such as a Controller Area Network (CAN). When being updated, the AUTOSAR-based ECU simply uploads codes and data, but does not perform an original function. If a developer develops an AUTOSAR-based application software and attempts to update the AUTOSAR-based ECU using the AUTOSAR-based application software, unnecessary functions needs to be transferred and a significant number of codes have to be implemented. Under this background, a technology, which allows an ECU to be updated at a high speed by omitting the need of transferring unnecessary functions, implementing codes and operating an OS, is proposed.

Meanwhile, an AUTOSAR platform does not provide an additional driver to be used only for updating an ECU, but simply requires a driver to be used for operating an OS. In this case, two communication driver, or two and more drivers in the same form are needed to update the ECU. Thus, a technology, which enables an ECU to be updated at a high speed by reducing memory waste led by the use of multiple drivers so that a user may be use the ECU more efficiently, is suggested.

A general communication process in an AUTOSAR-based ECU requires multiple operations, as shown in FIG. 1. That is, data received in the communication driver 10 is transmitted to the User Application 16 via the communication hardware abstraction unit 11, the PDUR 12, the COM 13 and the RTE 14.

The communication driver 10, the communication hardware abstraction unit 11, the PDUR 12 and the COM 13 are included in a Basic Software (BSW) module. The communication driver 10 is configured in a MicroController Abstraction Layer (MCAL) of the BSW module. The communication driver 10 may include a CAN driver, a FlexRay driver and a Local Interconnection Network (LIN) driver according to a type of a communication means to be used.

The communication hardware abstraction unit 11 is configured in an ECU abstraction layer (ECAL) of the BSW module. The communication hardware abstraction unit 11 may include a CAN Interface (IF), a FlexRay IF and a LIN IF according to a communication means to be used. In addition, the communication hardware abstraction unit 11 may include a CAN transceiver (TRCV), a FlexRay transceiver (TRCV) and a LIN transceiver (TRCV), according to a communication means to be used. The PDUR 12, the COM 13 and the Network Manager (NM) are configured in a service layer of the BSW module.

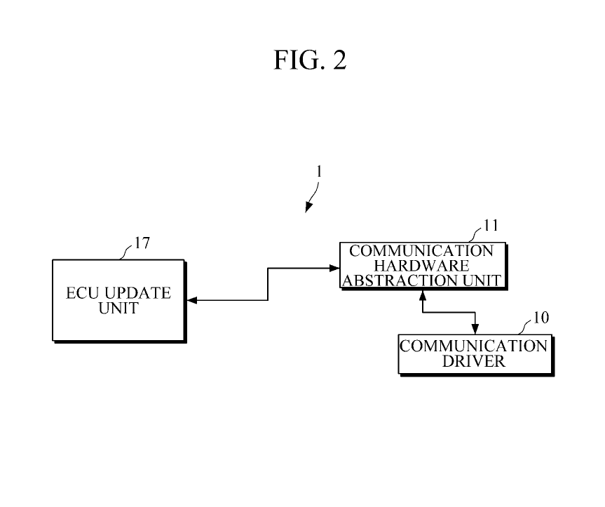

According to an exemplary embodiment of the present invention, data received by the communication driver 10 via a network is used in the communication hardware abstraction unit 11 to update the ECU. That is, instead of being transmitted to the User Application 16 via the communication hardware abstraction unit 11, the PDUR 12, the COM 13 and the RTE 14, the data received by the communication driver 10 is immediately used in the communication hardware abstraction unit 11 to update the ECU, so that unnecessary processes may be omitted. The above process will be described in detail with reference to FIG. 2.

Meanwhile, a conventional method for updating an ECU in accordance with the AUTOSAR standard requires interrupts, unnecessary tasks and Information Storage and Retrieval (ISR) for an OS, so that unnecessary codes and functions have to be implemented. If the unnecessary codes and functions are implemented, the ECU may be updated slowly. Default drivers are designed only for communication, but the need of updating an ECU is not taken into consideration. For this reason, a developer has to develop an ECU updating application.

Continuous occurrence of interrupts in the OP 15 affects the speed of updating the ECU, so two modes are utilized to control the OS 15 in the embodiments of the present invention. That is, a first mode, the ECU is updated when the OS 15 is operating, whereas, a second mode, the ECU is updated by stopping operation of the OS 15, and then the OS 15 re-operates after the ECU is completely updated.

In the first mode, the ECU is updated by omitting unnecessary functions when the OS 15 is operating. In the second mode, the ECU is updated by stopping operation of the OS 15 and stopping interrupts, except for interrupts required for updating the ECU, or, alternatively, the ECU is updated using a polling method by stopping all interrupts. The polling method is a transmission controlling method by which various modules in an ECU are inquired in a sequential order about whether to request data to be transmitted. If a module requests data to be transmitted, the requested data is transmitted to the corresponding module, and, if not, a next module is inquired about whether to request data to be transmitted.

FIG. 2 is a configuration of an ECU 1 to be updated in accordance with an extended AUTOSAR standard according to an exemplary embodiment of the present invention.

Referring to FIGS. 1 and 2, if data is received in a communication Interface (IF) of a communication hardware abstraction unit 11, the data may be transmitted to a Transport Protocol (TP), a PDUR and a Network Manager (NM) on a service layer. In addition, the data, which is received in the communication IF to update an ECU, is transmitted directly to an ECU update unit 17.

The ECU update unit 17 designates an area in the memory to be updated, the area which is predetermined using a function called to update the ECU, and then updates the ECU. Updating the ECU includes generating, deleting and modifying an ECU program.

As continuous occurrence of interrupts in the OS affects the speed of updating the ECU, the ECU update unit 17 controls operation of the OS using OS operation modes. In one embodiment, the ECU is updated when the OS is operating (that is, a START_OS_MODE). In another embodiment, the ECU is updated by stopping operation of the OS (that is, a STOP_OS_MODE), and then the OS re-operates after the ECU is completely updated (that is, a START_OS_MODE).

When the ECU is updated by stopping operation of the OS (in a STOP_OS_MODE), various updating methods may be employed. That is, the ECU may be updated by stopping the operation of the OS and stopping interrupts, except for interrupts required for updating the ECU (that is, a CAN_INTERRUPT_MODE). Alternatively, the ECU may be updated using a polling method by stopping all interrupts (that is, a CAN_POLLING_MODE).

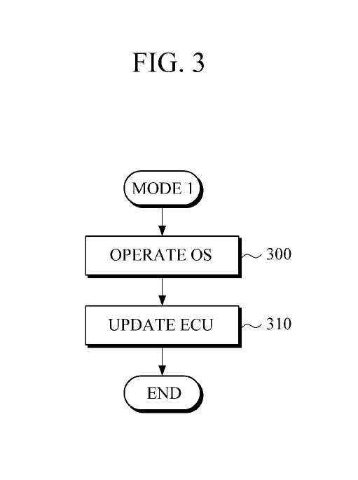

FIG. 3 is a flow chart illustrating a method for updating an ECU according to an exemplary embodiment of the present invention.

Referring to FIGS. 2 and 3, when an OS is operating in 300, an ECU update unit 17 updates an ECU in 310. In this case, the ECU is updated by omitting unnecessary functions while maintaining general operations of the OS.

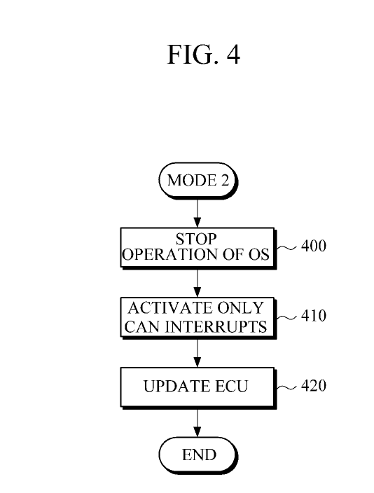

FIG. 4 is a flow chart illustrating a method for updating an ECU according to another exemplary embodiment of the present invention.

Referring to FIGS. 2 and 4, after stopping operation of an OS in 400, an ECU update unit 17 stops interrupts except for interrupts required for updating the ECU in 410 and then updates the ECU in 420. In this case, the ECU may be updated at a high speed by omitting unnecessary functions and stopping interrupts which continuously occur in the OS.

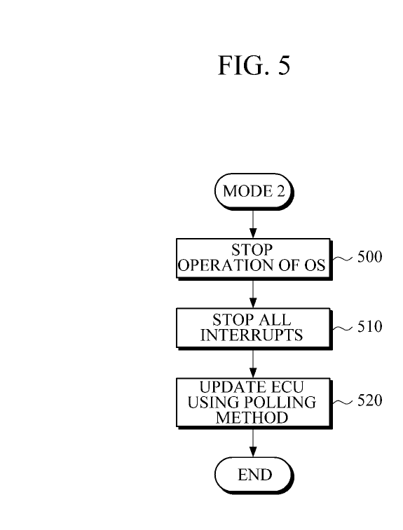

FIG. 5 is a flow chart illustrating a method for updating an ECU according to another exemplary embodiment of the present invention.

Referring to FIGS. 2 and 5, after stopping operation of an OS in 500, an ECU update unit 17 stops all interrupts in 510 and then updates the ECU using a polling method in 520. In this case, the ECU is updated at a high speed by omitting unnecessary functions and stopping interrupts which continuously occurs in the OS.

According to an exemplary embodiment of the present invention, an ECU may be updated at a high speed while concurrently performing an operation in accordance with the AUTOSAR standard. Furthermore, an ECU developer is able to rapidly develop an application by selecting to update the ECU when setting a driver, rather than developing additional application software required for updating the ECU. In addition, it is unnecessary to utilize drivers in the same form, so that memory waste may be reduced.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Automobile Open System Architecture (AUTOSAR)-based Electronic Control Unit (ECU) comprising:
a communication driver;
a communication hardware abstraction unit configured to receive data to be updated from a communication driver; and
an ECU update unit configured to update an ECU using the received data.

2. The AUTOSAR-based ECU of claim 1, wherein the ECU update unit updates the ECU by receiving the data directly from the communication hardware abstraction unit, rather than transmitting the data to a User Application via a Protocol Data Unit Router (PDUR), a COM and a RunTime Environment (RTE).

3. The AUTOSAR-based ECU of claim 1, wherein, when updating the ECU, the ECU update unit is capable of selecting whether to operate an Operating system (OS).

4. The AUTOSAR-based ECU of claim 3, wherein the ECU update unit, in a first mode, updates the ECU when the OS is operating, and, in a second mode, stops operation of the OS to update the ECU and then re-operates the OS when the ECU is completely updated.

5. The AUTOSAR-based ECU of claim 4, wherein the ECU update unit, in the second mode, updates the ECU by activating Controller Area Network (CAN) interrupts required for updating the ECU while stopping all interrupts except for CAN interrupts.

6. The AUTOSAR-based ECU of claim 4, wherein the ECU update unit, in the second mode, updates the ECU using a polling method while stopping all interrupts including CAN interrupts.

7. The AUTOSAR-based ECU of claim 1, wherein the ECU update unit sets a parameter required for updating an area in a memory to be updated, and then sets a different driver to be selectively used.

8. The AUTOSAR-based ECU of claim 1, wherein the communication driver comprises a CAN driver.

9. The AUTOSAR-based ECU of claim 1, wherein the communication hardware abstraction unit comprises a CAN interface.

10. A method for updating an AUTOSAR-based ECU, the method comprising:
receiving, in a communication hardware abstraction unit, data to be updated from a communication driver data; and
updating an ECU in the ECU update unit using the data received from the communication hardware abstraction unit.

11. The method of claim 10, wherein the updating of an ECU comprises updating the ECU by receiving the data directly from the communication hardware abstraction unit, rather than transmitting the data to a User Application via a PDUR, a COM and a RTE.

12. The method of claim 10, wherein the updating of an ECU comprises either or both of, in a first mode, updating an ECU when an OS is operating, and, in a second mode, updating the ECU by stopping operation of the OS.

13. The method of claim 12, wherein the updating of an ECU in the second mode comprises updating the ECU by activating only CAN interrupts required for updating the ECU while stopping other interrupts.

14. The method of claim 12, wherein the updating of an ECU in the second mode comprises suspending all interrupts including CAN interrupts, and updating the ECU based on a polling method.

15. The method of claim 10, wherein the updating of an ECU comprises setting a parameter required for updating an area in a memory to be updated and then setting a different driver to be selectively used.
